(19) United States
(12) Patent Application Publication
(10) Pub. No.: US 2005/0096089 A1
(43) Pub. Date: May 5, 2005

(54) Base station apparatus and method of allocating resource at base station apparatus

(75) Inventors: Hidenori Ishii, Setagaya-ku (JP); Toshiaki Nagasawa, Sagamihara-shi (JP); Kenji Takagi, Yokohama-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/978,723

(22) Filed: Nov. 2, 2004

(30) Foreign Application Priority Data
Nov. 5, 2003 (JP) 2003-376125

(51) Int. Cl. H04Q 7/20

(52) U.S. Cl. 455/561; 455/560

(57) ABSTRACT

A base station apparatus 102 is provided with a terminal state management section 107 that manages the state as to whether a communication terminal apparatus 101 which belongs to the cell covered by the own apparatus is in communication or waiting for a call, a decision section 1051 that decides whether the communication terminal apparatus 101 is stationary or moving and a resource reservation allocation section 1052 that allocates reservations of resources according to the respective numbers of moving terminal apparatuses and stationary terminal apparatuses calculated based on the decision result, and performs state management according to the actual state of the communication terminal apparatus 101 and allocates resources to the respective moving terminal apparatuses and stationary terminal apparatuses appropriately.

### BACKGROUND OF THE INVENTION

1. Field of the Invention

The present invention relates to a base station apparatus which carries out radio communications with communication terminal apparatuses and a method of allocating resources at the base station.

2. Description of Related Art

The proliferation of cellular phone sets in recent years is remarkable and a cellular phone service based on a W-CDMA (Wideband Code Division Multiple Access) standard started for the first time in Japan in 2001. With regard to communication technologies, wideband transmission, for example, a service of 384 kbps become possible as of 2002 with the introduction of W-CDMA to digital cellular phone sets which used to be dedicated only to speech and low-speed packet communications.

Furthermore, diversification of the communication mode is progressing not only in the W-CDMA but also in overall fields of communication. The number of high-speed transmission call such as video conference call and the number of traffic types, which occur in a cell covered by a base station apparatus (coverage area) are growing since W-CDMA provides a variety of applications taking advantage of wideband transmission. Moreover, though it is people who have been mainly using wireless communications so far, examples of applications of inter-machine communications, such as physical distribution and telemetering with the progress of cost reductions in communication modules, are increasing.

On the other hand, with regard to base stations, the use of a high-frequency band in which propagation distances become shorter than those in a low-frequency band assuming that both have the same output narrows the cell per base station, and thereby a mobile operator requires many base stations to expand its radio network service area, which tends to increase the installation cost. Therefore, a possible way to expand the service area at a lower cost may be install many low-cost and small capacity base stations accommodating several tens of channels.

Furthermore, when the nature of traffic for each base station is considered, large-capacity base stations are installed in places with a large amount of traffic requiring a high accommodation capacity, and therefore variations in traffic may also be considered to be moderate according to a law of large numbers in statistics when viewed as a whole. However, with the downsizing of a cell per base station, diversification of traffic types and diversification of communication terminal apparatuses, variations of traffic in a cell of one base station relatively increase. For small-capacity base stations in particular, it becomes more frequent that the amount of traffic increases and exhausts the total accommodation capacity of the base station. In that case, the base station is required to decide more important calls and provide services to those calls with higher priority.

For example, Japanese Patent Publication No. HEI 8-9464 discloses a scheme of a communication network in a small cell configuration such as W-CDMA in which resources of a base station are allocated to communication terminal apparatuses which do not move from one cell to another (hereinafter referred to as “stationary terminal apparatuses”) with higher priority. Here, resources mainly refer to a hardware processing capacity necessary to carry out a baseband signal, and the resource allocation scheme includes a scheme for allocating, for example, transmit power of radio channels, amount of interference, storage areas necessary to allocate the channels., and channelization codes in CDMA.

Resources are allocated to stationary terminal apparatuses preferentially because communication terminal apparatuses carrying out communications while moving from one cell to another (hereinafter referred to as “moving terminal apparatuses”) communicate with a plurality of base stations simultaneously, carrying out so-called inter-cell handover, and these moving terminal apparatuses consume more than double resources of stationary terminal apparatuses which do not move from one cell to another when viewed from the whole network.

Furthermore, the moving terminal apparatuses provoke interference in a wider range than that of stationary terminal apparatuses. For these reasons, the moving terminal apparatuses have the potential for degrading quality of radio communications of the stationary terminal apparatuses located near the moving terminal apparatuses and provoking forced interruption. In this case, even if a communication is suddenly interrupted due to approach of a moving terminal apparatus, the user of the stationary terminal apparatus cannot recognize the cause thereof. Thus, interruption of communication of a stationary terminal apparatus is often more inconvenient than the case where a communication of a moving terminal apparatus is interrupted.

Thus, the conventional technology described in the Unexamined Japanese Patent Publication No. 8-9464 discloses a scheme in which resources to be allocated by a base station are divided into resources for moving terminal apparatuses and resources for stationary terminal apparatuses, and resources for moving terminal apparatuses are allocated to calls of the moving terminal apparatuses and resources for stationary terminal apparatuses are preferentially allocated to the stationary terminal apparatuses. According to this conventional resource allocation scheme, when a communication terminal apparatus enters a cell by carrying out handover, the base station apparatus having that cell treats the communication terminal apparatus as a moving terminal apparatus and when a communication terminal apparatus originates a call in the base station apparatus' own cell, the base station apparatus treats the communication terminal apparatus as a stationary terminal apparatus as long as the communication terminal apparatus stays in the base station apparatus' own cell.

Furthermore, each base station measures an amount of call made in each cell at certain interval, increases resources for stationary terminal apparatuses and decreases resources for moving terminal apparatuses when the amount of call made exceeds a predetermined threshold. On the contrary, when the amount of call made falls below the threshold, the base station apparatus increases the resources for moving terminal apparatuses and decreases the resources for stationary terminal apparatuses. In this way, when the amount of call made is small, the resources for moving terminal apparatuses are increased and resources can be reliably allocated to a communication terminal apparatus which enters from another cell, whereas when the amount of call made is large, the resources for moving terminal apparatuses are decreased and therefore resources are reliably allocated to stationary terminal apparatuses, with the result that it is possible to improve the accommodation capacity when viewed as a whole network.

However, a conventional base station apparatus does not consider whether communication terminal apparatuses which belong to the area covered by the base station are waiting for a call or not and does not manage whether the communication terminal apparatuses in that state are stationary or moving as a natural consequence, resulting in a problem that resources cannot be allocated to stationary terminal apparatuses and moving terminals appropriately.

Furthermore, in the case of the conventional base station apparatus, even if a communication terminal apparatus assigned as a stationary terminal apparatus moves, the base station apparatus continues to treat the communication terminal apparatus as a stationary terminal apparatus as long as it stays in the same cell and when the communication terminal apparatus approaches a communication terminal apparatus which is actually stationary, the communication terminal apparatus may cause interference.

### SUMMARY OF THE INVENTION

It is an object of the present invention to provide a base station apparatus and a method of allocating resource reservations capable of deciding whether a communication terminal apparatus is stationary or moving taking into consideration whether the communication terminal apparatus is waiting for a call or not and appropriately allocating resources to moving communication terminal apparatuses and stationary communication terminal apparatuses.

An aspect of the invention is a base station apparatus comprising a terminal state decision section that decides a terminal state as to whether a communication terminal apparatus which belongs to a cell covered by the base station apparatus is in communication or waiting for a call, a decision section that decides whether the communication terminal apparatus decided by the terminal state decision section as being in communication or waiting for a call is stationary or moving and creates a decision result and a resource reservation allocation section that reserves resources for the respective apparatuses according to the number of the moving communication terminal apparatuses and the number of the stationary communication terminal apparatuses based on the decision result.

Another aspect of the invention is a method of allocating resource reservations at a base station apparatus comprising a step of deciding whether a communication terminal apparatus is waiting for a call or not, a step of deciding whether the communication terminal apparatus decided as being waiting for a call is stationary or moving and creating a decision result and a resource reservation allocating step of reserving resources for the respective apparatuses according to the number of the moving communication terminal apparatuses and the number of the stationary communication terminal apparatuses based on the decision result.

### BRIEF DESCRIPTION OF THE DRAWINGS

The above and other objects and features of the invention will appear more fully hereinafter from a consideration of the following description taken in connection with the accompanying drawing wherein one example is illustrated by way of example, in which; The above and other objects and features of the invention will appear more fully hereinafter from a consideration of the following description taken in connection with the accompanying drawing wherein one example is illustrated by way of example, in which;

FIG.1 is a block diagram showing a configuration of a base station apparatus according to Embodiment 1;

FIG.2 illustrates a field of a terminal state management section of the base station apparatus according to Embodiment 1;

FIG.3 illustrates a resource state management section field of the base station apparatus according to Embodiment 1;

FIG.4 illustrates a terminal state managed by the terminal state management section of the base station apparatus according to Embodiment 1;

FIG.5 illustrates a resource state managed by the resource state management section of the base station apparatus according to Embodiment
1;

FIG. 6 illustrates a variation of a terminal state of a communication terminal apparatus at the terminal state management section when a communication terminal apparatus is operated;

FIG.7 is a flow chart of a channel allocation process and a channel release process carried out by the base station apparatus according to Embodiment 1;

FIG.8 is a flow chart of an ATTACH process carried out by the base station apparatus according to Embodiment 1;

FIG.9 is a flow chart of a resource reservation process carried out by the base station apparatus according to Embodiment 1;

FIG.10 is a flow chart of a dedicated channel securing process carried out by the base station apparatus according to Embodiment 1;

FIG. 11 is a flow chart of a process carried out by the base station apparatus according to Embodiment 1 when a periodic signal is lost;

FIG. 12 illustrates a variation in the terminal state at the terminal state management section of the base station apparatus when a communication terminal apparatus moves from one cell to another through inter-cell handover; and

FIG.13 is a block diagram showing a configuration of a base station apparatus according to Embodiment 2;

FIG.14 illustrates a field of a terminal state management section of the base station apparatus according to Embodiment 2.

### DESCRIPTION OF THE PREFERRED EMBODIMENTS

Embodiments of the present invention will be explained below. In this embodiment, a base station apparatus decides and manages states of communication terminal apparatuses which belong to an area covered by the base station apparatus as to whether the communication terminal apparatuses are in communication or waiting for a call, decides whether the communication terminal apparatuses are stationary or moving according to the actual states of the communication terminal apparatuses not only when the communication terminal apparatuses are in communication but also when they are waiting for a call and appropriately allocates resources of the base station apparatus to the respective moving communication terminal apparatuses and stationary communication terminal apparatuses.

### Embodiment 1

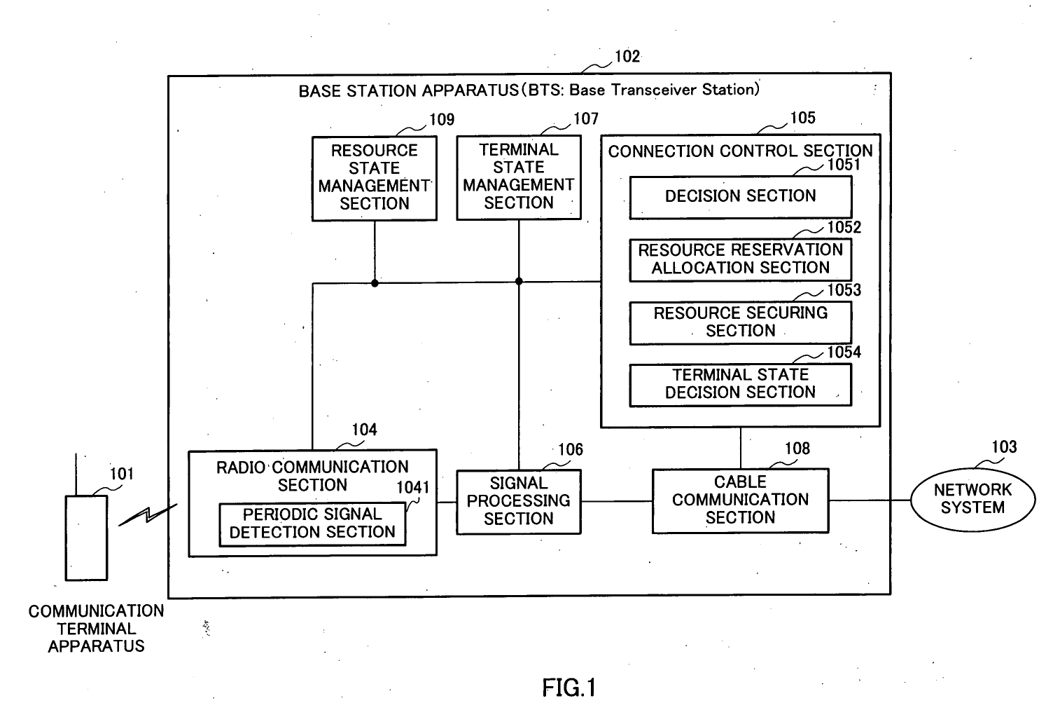

FIG.1 is a block diagram showing a configuration of a base station apparatus 102 according to Embodiment 1. In FIG. 1, the base station apparatus 102 communicates with a communication terminal apparatus 101 by radio and communicates with a network system 103 using a cable. The base station apparatus 102 accommodates the communication terminal apparatus 101 in a cell thereof, transmits and receives a radio signal to/from the communication terminal apparatus 101 and converts the signal to a cable signal. The network system 103 has a switching function and is connected to the base station apparatus 102 through a dedicated line or ATM (Asynchronous Transfer Mode).

In the following descriptions, the communication terminal apparatus 101 will be described assuming a case of a third-generation cellular phone set according to W-CDMA (Wideband Code Division Multiple Access) scheme or MC-CDMA (Multi-Carrier CDMA), but the communication terminal apparatus 101 is also applicable to a cellular phone set or cordless telephone set such as GSM (Global System for Mobile communications), PHS (Personal Handy-phone System), PDC (Personal Digital Cellular).

The base station apparatus 102 is provided with a radio communication section 104, a connection control section 105, a signal processing section 106, a terminal state management section 107, a cable communication section 108 and a resource state management section 109. The radio communication section 104 is provided with a periodic signal detection section 1041. The connection control section 105 is provided with a decision section 1051, a resource reservation allocation section 1052, a resource securing section 1053 and a terminal state decision section 1054.

The radio communication section 104 transmits/receives a radio signal to/from the communication terminal apparatus 101. The radio communication section 104 is provided with an antenna, an amplifier, a power supply for transmission and a control program and performs control over transmit power of the communication terminal apparatus 101 and modulation processing, etc., of a radio/cable signal. The periodic signal detection section 1041 detects signals periodically output by the communication terminal apparatus 101.

The connection control section 105 performs connection control and disconnection control of a communication with the communication terminal apparatus 101 according to a request from the network system 103. The connection control section 105 is normally mounted as a program inside a control card of the base station. The decision section 1051 decides whether the communication terminal apparatus 101 which exists in the cell of the base station apparatus 102 is a moving terminal apparatus or a stationary terminal apparatus. This embodiment assumes in principle that a terminal which has moved from one cell to another is a moving terminal apparatus, while a terminal which does not move from one cell to another is a stationary terminal apparatus. However, after power is turned ON, immediately after an ATTACH process is completed, the initial setting of the terminal state is a moving terminal apparatus. This is because since the base station apparatus 102 cannot distinguish the moving terminal apparatus from the stationary terminal apparatus through ATTACH alone, the base station apparatus only allocates resources for a stationary terminal apparatus to a communication terminal apparatus 101 which is clearly identifiable as a stationary terminal apparatus. When the position information of the communication terminal apparatus 101 can be specified according to some scheme (when the base station apparatus 102 receives position information from the terminal or uses a radio wave state or other position measuring scheme, etc., to know the position of the terminal accommodated or receives the position information of the communication terminal apparatus 101 from the network system 103 including an RNC (Radio Network Controller), the base station apparatus 102 can detect whether the terminal in the cell is moving or not, and therefore based on this information, it is also possible to decide whether the terminal is a moving terminal apparatus or stationary terminal apparatus. The resource reservation allocation section 1052 allocates reservation resources of the base station apparatus 102 for a moving terminal apparatus and stationary terminal apparatus based on the number of moving terminal apparatuses and stationary terminal apparatuses decided by the decision section 1051 and rewrites the resource state of the resource state management section. The resource securing section 1053 secures or releases resources and rewrites the resource state of the resource state management section 109. The terminal state decision section 1054 decides terminal states as to whether the communication terminal apparatus 101 is in communication or waiting for a call, etc., and rewrites the terminal state of the terminal state management section 107.

The signal processing section 106 performs signal processing such as coding/modulation processing on a radio signal from the communication terminal apparatus 101 and conversion to a cable signal. According to the decision by the decision section 1051, the terminal state management section 107 manages the terminal states as to whether the communication terminal apparatus 101 is a moving terminal apparatus or a stationary terminal apparatus or whether the communication terminal apparatus 101 is in communication or waiting for a call. The cable communication section 108 transmits/receives a signal to/from the network system 103. The resource state management section 109 manages the resource states of the base station apparatus 102.

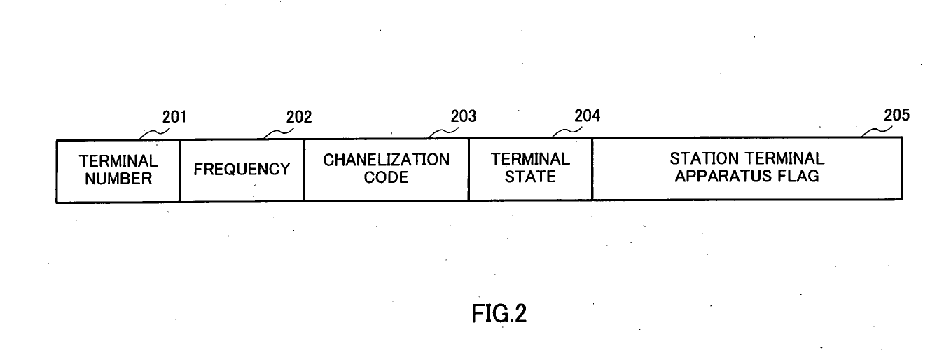

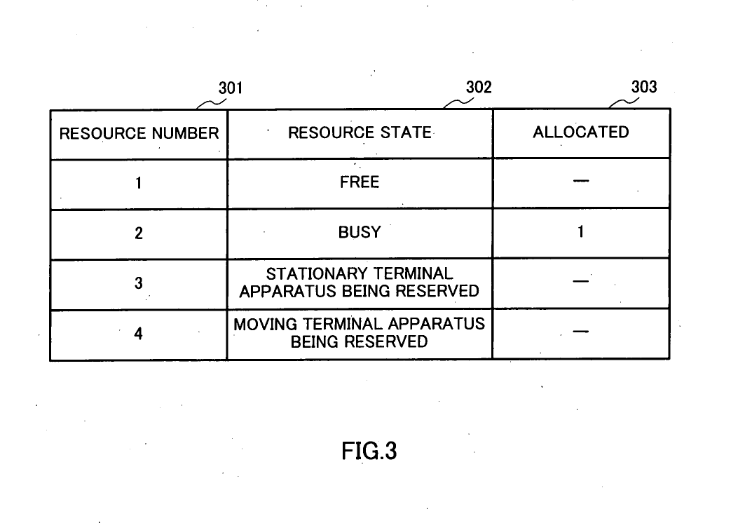

FIG.2 and FIG.3 illustrate fields of the terminal state management section 107 and resource state management section 109 respectively.

A terminal number 201 is a unique number assigned to each communication terminal apparatus 101 and the base station apparatus 102 identifies the communication terminal apparatus 101 using this terminal number 201. A frequency 202 records a frequency at which the communication terminal apparatus 101 communicates.

A channelization code 203 is a channelization code to identify the communication terminal apparatus 101 in the cell of the base station apparatus 102. In W-CDMA scheme, a scrambling code is assigned to each base station apparatus 102 and a channelization code is assigned to each communication terminal apparatus 101. Both codes are combined to create one code and thereby a channel through which the base station apparatus 102 communicates with the communication terminal apparatus 101 is identified.

A terminal state 204 stores a terminal state of the communication terminal apparatus 101. The contents of the terminal state 204 will be described later. A stationary terminal apparatus flag 205 is a flag to distinguish a moving terminal apparatus from a stationary terminal apparatus. The stationary terminal apparatus flag 205 is set to ON with data of the communication terminal apparatus 101 decided to be a stationary terminal apparatus by the decision section 1051.

A resources number 301 is a unique number assigned to each resource and is intended to identify resources. A resource state 302 is intended to record a resource state. The contents of the resource state 302 will be described later.

An allocation terminal number 303 is a terminal number of the communication terminal apparatus 101 to which a resource is allocated. This embodiment is premised on that a communication terminal apparatus has a one-to-one correspondence with a call. Otherwise, it is equally possible to achieve the thing described above by storing information for identifying a call instead of the allocation terminal number 303.

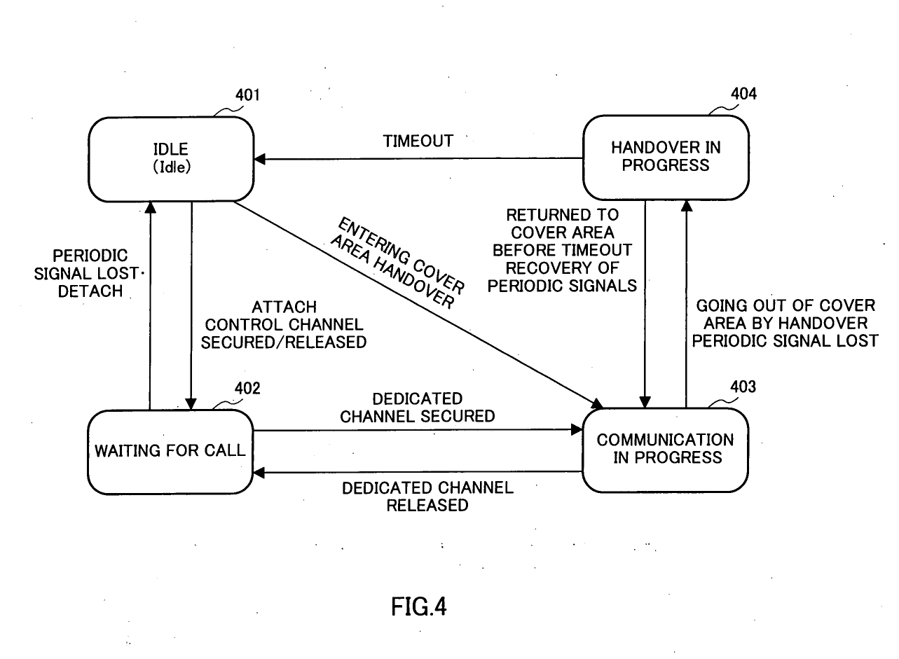

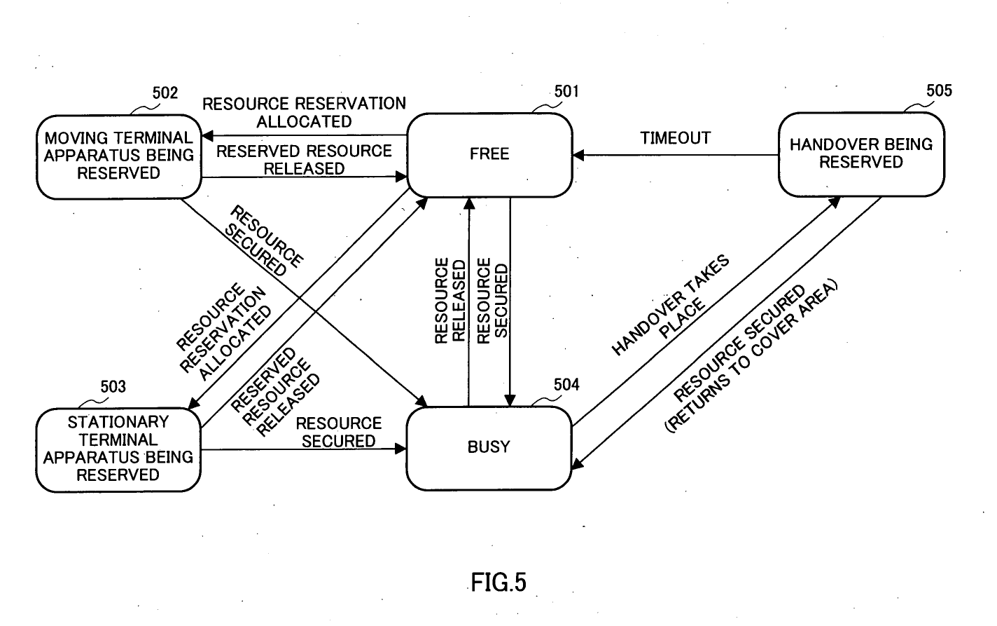

FIG.4 illustrates terminal states managed by the terminal state management section 107 of the base station apparatus 102. The terminal states include an “idle” state, “waiting for a call” state, “communication in progress” state and “handover in progress” state. (1) The “idle” state (401) refers to a state in which the communication terminal apparatus 101 has generated no signal (not registered in the terminal state management section 107). (2) The “waiting for a call” state (402) refers to a state in which the communication terminal apparatus 101 has performed ATTACH (a position registration process) and is ready to receive a call. (3) The “communication in progress” state (403) refers to a state in which the base station apparatus 102 has secured a dedicated channel allocated by the base station apparatus 102 to each communication terminal apparatus 101 and the communication terminal apparatus 101 and base station apparatus 102 are communicating anything other than ATTACH. (4) The “handover in progress” state (404) refers to a state in which detection of a signal from the communication terminal apparatus 101 is interrupted during a communication. When a preset timeout time has elapsed after the terminal state was put in the “handover in progress” state 404, the base station apparatus 102 regards that the signal of the communication terminal apparatus 101 has disappeared from the own cell and is put in the “idle” state 401.

FIG.5 illustrates a resource state managed by the resource state management section 109 of the base station apparatus 102. The resource state includes a “free” state, “moving terminal apparatus being reserved” state, “stationary terminal apparatus being reserved” state, “busy” state and “handover being reserved” state. (1) The “free” state (501) refers to a state in which a resource is available. (2) The “moving terminal apparatus being reserved” state (502) refers to a state in which reservations have been made according to the number of moving terminal apparatuses and the “stationary terminal apparatus being reserved” state (503) refers to a state in which reservations have been made according to the number of stationary terminal apparatuses. When a call is generated, it is not until there is no more free resource that a resource being reserved (hereinafter referred to as “reserved resource”) is allocated. (3) The “busy” state (504) refers to a state in which a communication is being carried out using resources. (4) The “handover being reserved” state (505) refers to a resource state when the communication terminal apparatus 101 to which a resource is allocated in the “busy” state 504 can no longer be detected by the base station apparatus 102 for some reason during a communication. When the base station apparatus 102 cannot detect the same communication terminal apparatus 101 for a certain period after transition to this state, the “free” state 501 starts.

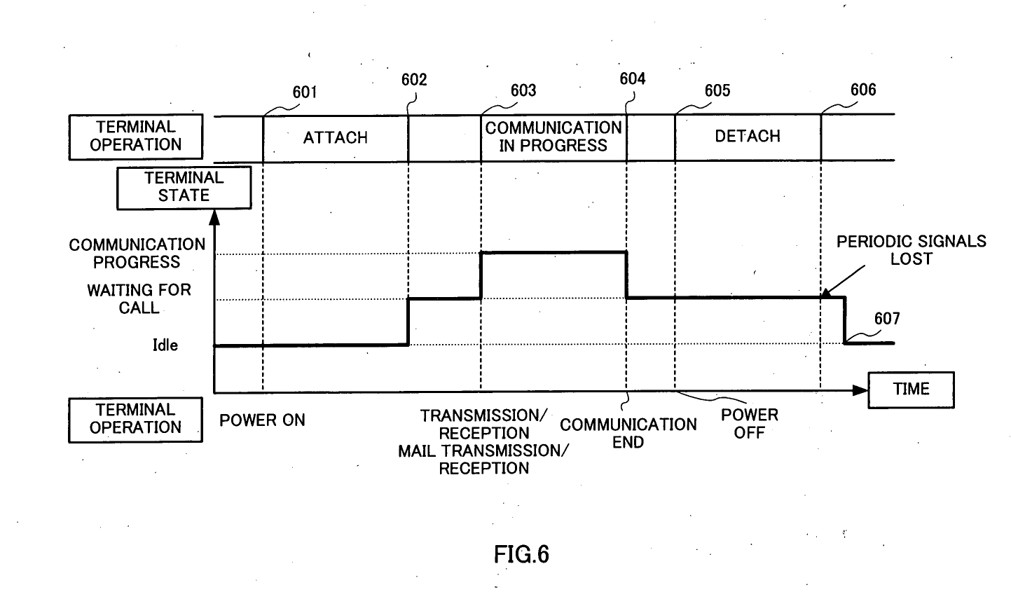

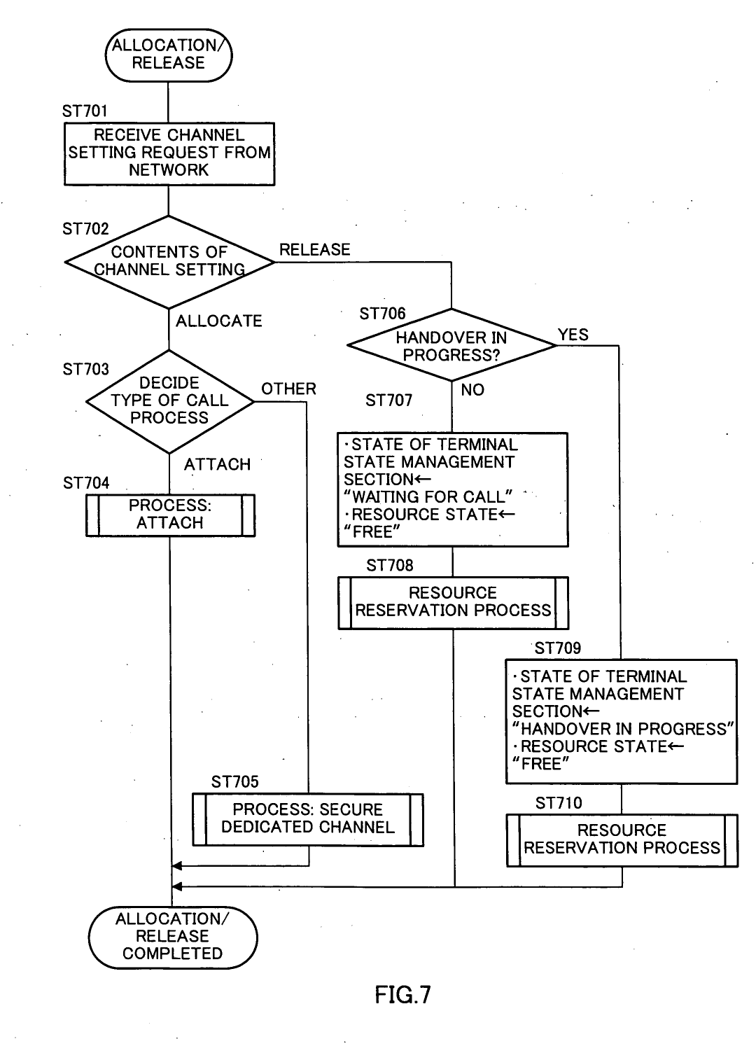

FIG.6 illustrates five processes (ATTACH, waiting for a call, communication start, communication end and DETACH) carried out by the communication terminal apparatus 101 when the user of the communication terminal apparatus 101 carries out four operations; power ON, transmission/reception of a call, and call connection and disconnection and changes in the terminal state at the terminal state management section 107 at the respective times. Along the time axis in FIG.6, the operation of the base station apparatus 102 will be explained with reference to the state transition charts in FIG.4 and FIG.5 and flow charts in FIG.7 to FIG.9.

First, the process when the power of the communication terminal apparatus 101 is turned ON (time 601 to time 602) will be explained.

When the power of the communication terminal apparatus 101 is turned ON, the communication terminal apparatus 101 registers the position in the network system 103 and carries out an ATTACH process which enables receiving a call from another communication terminal apparatus 101.

The communication terminal apparatus 101 sends a request to the network system 103 for an ATTACH dedicated channel through a common channel and the network system 103 outputs a channel setting request to the base station apparatus 102. Upon reception of the channel setting request, the base station apparatus 102 notifies the communication terminal apparatus 101 of the dedicated channel and the dedicated channel is allocated to the communication terminal apparatus 101 at the time 601. The communication terminal apparatus 101 notifies the network system 103 of the base station apparatus 102 to which the communication terminal apparatus 101 belongs using the dedicated channel, enables receiving a call from the other communication terminal apparatus 101 and then disconnects the dedicated channel at the time 602.

This flow will be explained in detail. First, a channel securing request from the communication terminal apparatus 101 to the network system 103 is output from the communication terminal apparatus 101 to the base station apparatus 102 through a common channel. The common channel is opened by the base station apparatus 102 at startup. Therefore, in response to the securing request from the communication terminal apparatus 101, the connection control section 105 does not perform any channel opening process, but the radio communication section 104 simply receives the request, the signal processing section 106 converts the request to a cable signal and the cable communication section 108 outputs the signal to the network system 103.

On the other hand, the network system 103 outputs a channel setting request to the base station apparatus 102. When the cable communication section 108 of the base station apparatus 102 receives this request, since the request is a channel setting request, the connection control section 105 detects this request and carries out a channel allocation process shown in FIG.7.

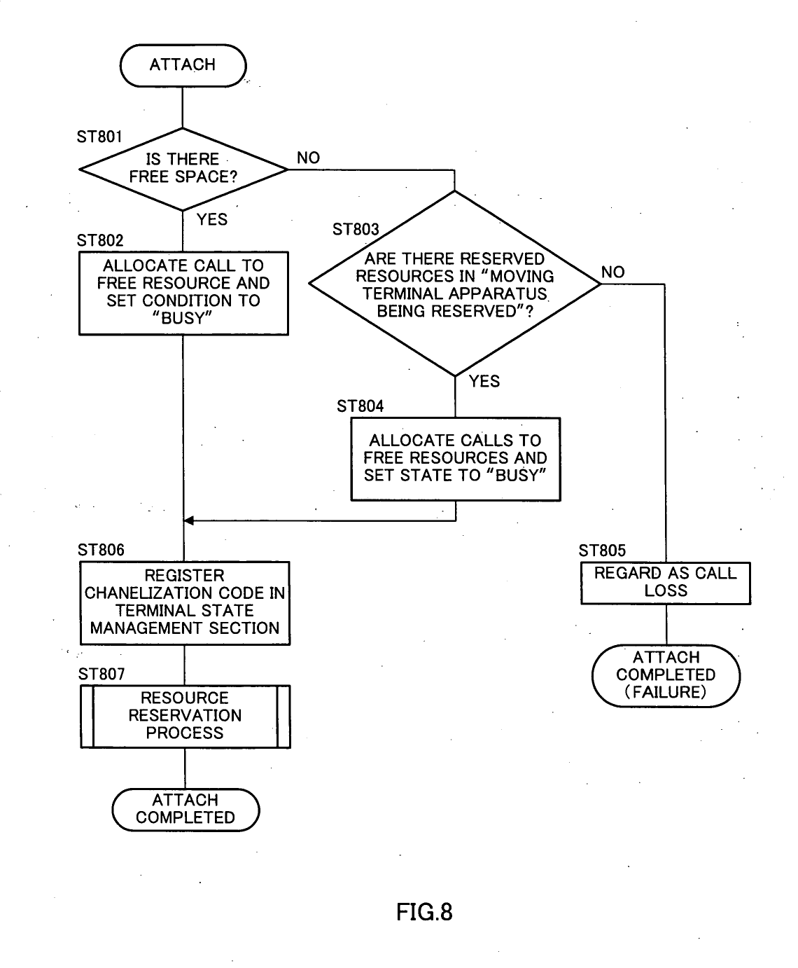

In FIG.7, the connection control section 105 receives the channel setting request (step ST701). In step ST702, the resource securing section 1053 decides the contents of the process of the channel setting request. In this case, since the channel setting request is a resource allocation process, the resource securing section 1053 moves to step ST703 and decides whether the request is ATTACH or not according to the contents of the channel setting request. When the contents of the channel setting request are ATTACH, in step ST704, the resource securing section 1053 gives a signal indicating that the contents of the channel setting request are ATTACH to the terminal state decision section 1054 and performs processing corresponding to ATTACH. Details of this processing corresponding to ATTACH will be explained using FIG.8.

The process corresponding to ATTACH in FIG.8 is divided into two processes; a process of allocating a resource to ATTACH and a resource reservation process accompanying a change in the number of terminals and the following processes are performed.

First, the resource securing section 1053 checks the presence/absence of a “free” state of resources at the base station apparatus 102 (step ST801). When there is any free resource (step ST801 YES), the resource securing section 1053 allocates ATTACH to the free resource (step ST802). When there is no free resource (step ST801 NO), the decision section 1051 decides that the communication terminal apparatus 101 is a moving terminal apparatus at the start of ATTACH, and therefore the resource securing section 1053 checks the presence/absence of a reserved resource for the moving terminal apparatus (step ST803). If there is any resource in a “moving terminal apparatus being reserved” state (step ST803 YES), the resource securing section 1053 allocates ATTACH to the resource (step ST804). When there is no resource in the “moving terminal apparatus being reserved” state (step ST803 NO), the remaining resources are busy or resources in a “stationary terminal apparatus being reserved” state, and therefore the resource securing section 1053 cannot allocate any resource to the ATTACH and regards the ATTACH as call loss (step ST805) In step ST802 or step ST804, when the resource securing section 1053 secures a resource for ATTACH, the resource securing section 1053 notifies the decision section 1051 that the channel has been secured, the decision section 1051 records the terminal number of the communication terminal apparatus 101 which has ATTACHed, sets the stationary terminal apparatus flag of the terminal state management section 107 to a flag indicating a moving terminal apparatus and records the frequency and channelization code (step ST806) Furthermore, the resource securing section 1053 decides about the resource that the resource state of the resource state management section 109 is “busy” and records an allocation terminal number. Then, the resource securing section 1053 gives a signal indicating that a resource has been secured for the ATTACH to the terminal state decision section 1054. Upon reception of the signal indicating that the contents of the above described channel setting request are ATTACH and that a resource has been secured for the ATTACH, the terminal state decision section 1054 decides that the terminal state of the communication terminal apparatus 101 is a “waiting for a call” state and sets the terminal state 204 in the field of the terminal state management section 107 to the “waiting for a call state” 402. In this embodiment, the decision section 1051 handles the communication terminal apparatus 101 as a moving terminal apparatus first, and therefore sets the stationary terminal apparatus flag 205 to OFF. This embodiment assumes that terminals which have been newly registered and have no past history included in the base station apparatus 102 are moving terminal apparatuses, but when the communication terminal apparatus 101 notifies the base station apparatus 102 of the terminal state through a different type of communication scheme such as wireless LAN and the network system 103 can distinguish whether the terminal is a stationary terminal apparatus or moving terminal apparatus, it is also possible to set the stationary terminal apparatus flag to ON from the beginning.

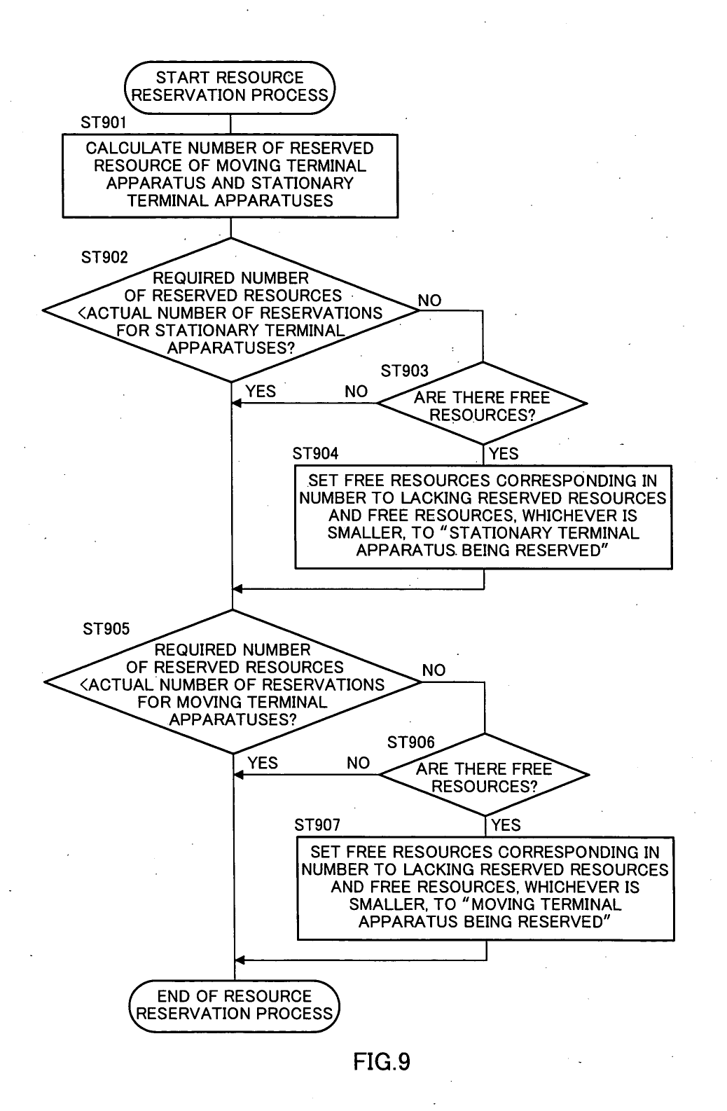

Next, when the stationary terminal apparatus flag 205 of the terminal state management section 107 changes, the resource reservation allocation section 1052 of the connection control section 105 carries out a resource reservation process (FIG.9) (step ST807). When this resource reservation process is completed, the ATTACH process in FIG.8 is also completed and the allocation/release process in FIG.7 is also completed.

Details of the resource reservation process (step ST807) will be explained using FIG.9. This resource reservation process is a common process which is also used to release resources, etc.

First, the resource reservation allocation section 1052 calculates the required number of reserved resources and the number of lacking resources with respect to the required number of reserved resources of the stationary terminal apparatuses and moving terminal apparatuses (step ST901). The resource reservation allocation section 1052 searches the terminal state management section 107,and checks the number of stationary terminal apparatuses (Num_Still) and the number of moving terminal apparatuses (Num_Moving). Then, the resource reservation allocation section 1052 multiplies the numbers of the respective terminals by certain rates (rate of stationary terminal apparatuses: Rate_Still, rate of moving terminal apparatuses: Rate_Moving) and calculates the required numbers of reserved resources of the stationary terminals apparatuses and moving terminal apparatuses.

The required number of reserved resources is a value obtained by multiplying the respective values of the stationary terminal apparatuses and moving terminal apparatuses by constants and can be expressed by the following expressions.

Required number of reserved resources for stationary terminal apparatuses (Reserv_Still)=Num_Still×Rate_Still
Required number of reserved resources for moving terminal apparatuses (Reserve_Moving)=Num_Moving×Rate_Moving

Here, Reserve_Still is the required number of reserved resources for stationary terminal apparatuses and Rate_Still is the ratio of the total number of stationary terminal apparatuses to the number of communication terminal apparatuses in communication among the stationary terminal apparatuses. Likewise, Reserve_Moving is the required number of reserved resources for moving terminal apparatuses and Rate_Moving is the ratio of the total number of moving terminal apparatuses to the number of communication terminal apparatuses in communication among the moving terminal apparatuses.

First, the resource reservation allocation section 1052 compares the required number of reserved resources for stationary terminal apparatuses Reserve_Still with the number of resources currently in “stationary terminal apparatus being reserved” state Present_Still (step ST902). When the former is smaller (step ST902 YES), there is no need to make further reservations, and so the resource reservation allocation section 1052 moves to the resource reservation process for moving terminal apparatuses from step ST905 onward. When the number of current reserved resources is lacking (step ST902 NO) the resource reservation allocation section 1052 checks the presence/absence of any free resources (step ST903). When there are some free resources (step ST903 YES), the resource reservation allocation section 1052 calculates the number of lacking resources which should be reserved Deficiency_Still using an expression (Deficiency_Still=Present_Still−Reserve_Still).

Here, the number of lacking resources Deficiency_Still becomes a negative number when resources are lacking. Then, the resource reservation allocation section 1052 newly sets the free resources corresponding to the number of lacking resources Deficiency_Still to “stationary terminal apparatus being reserved” or when the number of free resources is smaller than the number of lacking resources Deficiency_Still, the resource reservation allocation section 1052 newly sets resources corresponding to the number of free resources to “stationary terminal apparatus being reserved” (step ST904).

Next, the resource reservation allocation section 1052 compares the required number of reserved resources for moving terminal apparatuses Reserve_Moving with the number of resources currently in “moving terminal apparatus being reserved” state Present_Moving (step ST905). When the former is smaller (step ST905 YES), there is no need to make further reservations, and therefore the resource reservation allocation section 1052 finishes the resource reservation process. When the number of current reserved resources is insufficient (step ST905 NO), the resource reservation allocation section 1052 checks the presence/absence of free resources (step ST906). When there are some free resources (step ST907 YES), the resource reservation allocation section 1052 calculates the number of lacking resources which should be reserved Deficiency_Moving using an expression (Deficiency_Moving =Present_Moving−Reserve_Moving) first.

Here, when resources are lacking, the number of lacking resources Deficiency_Moving becomes a negative number. Then, the resource reservation allocation section 1052 newly sets free resources corresponding to the number of lacking resources Deficiency_Moving to “moving terminal apparatus being reserved” or when the number of free resources is smaller than the number of lacking resources Deficiency_Moving, the resource reservation allocation section 1052 newly sets resources corresponding in number to the free resources to “moving terminal apparatus being reserved” (step ST907). This completes the resource reservation process.

As shown above, after the process of resource allocation to the ATTACH is completed, an ATTACH registration process is carried out between the communication terminal apparatus 101 and network system 103. When this ATTACH occurs, the terminal state decision section 1054 sets the terminal state of the communication terminal apparatus 101 to a “waiting for a call” state at the terminal state management section 107. When the ATTACH ends, the channel release process shown in FIG. 7 is carried out at time 602 in FIG.6. Here, since the channel setting contents are “release”, the resource securing section 1053 moves from step ST702 to step ST706 and since it is decided in step ST706 that this process is not the process when handover is in progress, the resource securing section 1053 returns the resource state from the “busy” 504 to “free” 501 (step ST707). Then, the resource reservation allocation section 1052 carries out a resource reservation process (step ST708).

The above described process of the communication terminal apparatus 101 when power is ON is also the process carried out when a terminal enters from another cell to the own cell while the communication terminal apparatus 101 is waiting for a call.

Next, the “waiting for a call” process (time 602 to time 603) of the communication terminal apparatus 101 will be explained.

During the waiting time from time 602 to time 603, the terminal state 204 of the terminal state management section 107 is “waiting for a call.” The decision section 1051 decides whether the communication terminal apparatus 101 whose terminal state 204 is “waiting for a call” is a stationary terminal apparatus or moving terminal apparatus. Here, according to the W-CDMA scheme, the state of the layer 3 of the communication terminal apparatus 101 such as “waiting for a call” or “communication in progress” is managed by a mobile exchange (not shown) which makes up the network system 103. The role of the base station apparatus 102 is setting and releasing of physical channels and operation due to a state variation of the layer 3 is not ordinarily defined. Therefore, it is not possible to decide the state of the layer 3 based on the information of the layer 3 of the communication terminal apparatus 101 which passes through dedicated channels. Therefore, this embodiment shows a method of managing a “waiting for a call” state and “idle” state in a pseudo without using the layer 3 signal but using only signals acquired by the base station apparatus 102 connected to a normal public network. Here, when the base station apparatus 102 can acquire the layer 3 signals, for example, when a private branch exchange accommodates wireless extension terminal apparatuses, managing the state of the communication terminal apparatus 101 using the information can also obtain similar effects to those of this embodiment.

In a “waiting for a call” state, the decision section 1051 decides whether the communication terminal apparatus 101 is a stationary terminal apparatus or moving terminal apparatus because when the communication terminal apparatus 101 moves to another cell while waiting for a call or when the communication terminal apparatus 101 which has entered from another cell stands still in the own cell, it is possible to appropriately distinguish between a moving terminal apparatus and a stationary terminal apparatus by carrying out a process of rewriting the stationary terminal apparatus flag 205 and make resource reservations for the respective apparatuses and thereby protect the respective communications of the moving terminal apparatus and stationary terminal apparatus.

First, the “waiting for a call” state and the “idle” state are common in that no communication is being carried out and a method of deciding both states will be explained. Generally, the base station does not open any channel when a terminal is “waiting for a call” or when power is OFF and these two cannot be distinguished. In this embodiment, signals periodically output from the communication terminal apparatus 101 are detected using the periodic signal detection section 1041.

The periodic signal detection section 1041 is monitoring signals of all communication terminal apparatuses 101 currently accommodated by the base station apparatus 102 and when no signal to be monitored can be detected for a certain period or more, the periodic signal detection section 1041 sets the terminal state of the communication terminal apparatus 101 at the terminal management section 107 to the “idle” state 401 and deletes the terminal state from the terminal state management section 107. Furthermore, since the number of communication terminal apparatuses 101 counted as moving terminal apparatuses decreases, the resource reservation allocation section 1052 performs a resource reservation process.

A certain period used by the periodic signal detection section 1041 to detect signals to be monitored should be longer than intervals at which the communication terminal apparatus 101 outputs signals.

In this embodiment, during a period from time 602 to time 603 in FIG.6, the communication terminal apparatus 101 is in a “waiting for a call” state and continues to output signals periodically. In the mean time, the periodic signal detection section 1041 continues to receive signals output from the communication terminal apparatus 101, and therefore there is no change in the terminal state 204 of the terminal state management section and resource state 302 of the resource state management section 109.

This embodiment assumes that the communication terminal apparatus 101 is applied the W-CDMA scheme as described above, and therefore using a scrambling code output when the communication terminal apparatus 101 is carrying out intermittent reception while waiting for a call as the above described periodic signal, the decision section 1051 decides from the scrambling code that the communication terminal apparatus 101 is in a “waiting for a call” state. Furthermore, the communication terminal apparatus 101 which performs circuit switching outputs a “Periodic Location Update” during a speech conversation, and therefore similar effects can be obtained even when the periodic signal detection section 1041 uses “Periodic Location Update” as a signal to be monitored.

Next, a method of deciding whether the communication terminal apparatus 101 is a stationary terminal apparatus or moving terminal apparatus will be explained. Both when power is turned ON and when it enters from another cell to the own cell in a “waiting for a call” state, the communication terminal apparatus 101 executes an ATTACH. Since the operation which causes the ATTACH is unknown, the base station apparatus 102 cannot distinguish a stationary terminal apparatus from a moving terminal apparatus according to the ATTACH. Therefore, as a method of deciding a stationary terminal apparatus, it is possible to use a method in which when there is no inter-cell movement for a certain period after the communication terminal apparatus 101 enters the own cell, for example, for 30 minutes to one hour, and the periodic signal detection section 1041 continues to detect periodic signals output by the communication terminal apparatus 101, the decision section 1051 decides that the communication terminal apparatus 101 is a stationary terminal apparatus.

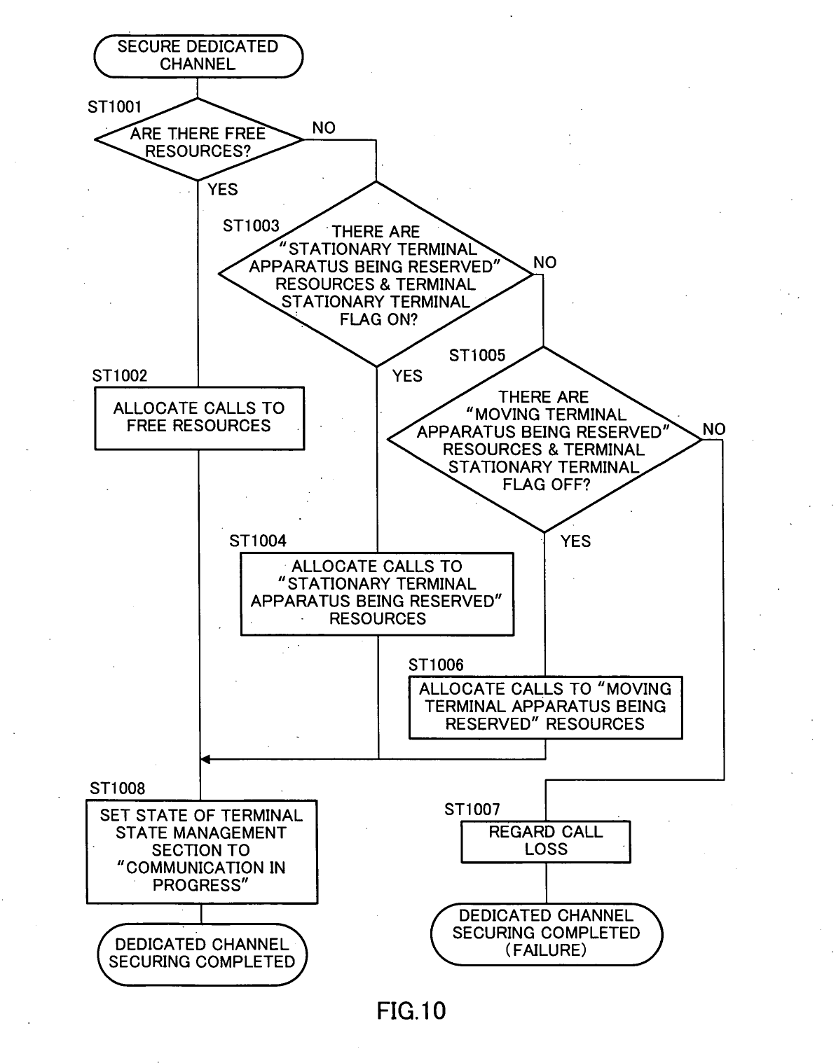

Next, the process of the base station apparatus 102 when the communication terminal apparatus 101 performs operations such as transmission and starts a communication will be explained with reference to FIG.10. FIG.10 is a flow chart of a dedicated channel securing process carried out by the base station apparatus 102.

When a communication is started, a dedicated channel is opened between the communication terminal apparatus 101 and base station apparatus 102. At that time, depending on whether the terminal state of the communication terminal apparatus 101 is a moving terminal apparatus or stationary terminal apparatus, the resource securing section 1053 of the connection control section 105 secures a dedicated channel for the communication terminal apparatus 101 as follows.

a) When there are free resources (step ST1001 YES) in the resource state management section 109, the resource securing section 1053 secures a free resource for a call (step ST1002). b) When there is no free resource (step ST1001 NO) but there is a reserved resource corresponding to the terminal state of the communication terminal apparatus 101 (stationary terminal apparatus flag ON “stationary terminal apparatus being reserved” resources, stationary terminal apparatus flag OFF→“moving terminal apparatus being reserved” resources) (step ST1003 YES, step ST1005 YES), the resource securing section 1053 secures the resource (step ST1004, step ST1006). c) When there is neither free resource nor reserved resource (step ST1003 NO and step ST1005 NO), the resource securing section 1053 regards the call as a call loss (step ST1007) In the cases of a) and b), if a resource is secured for the call, the resource securing section 1053 sets the terminal state of the terminal state management section 107 to a “communication in progress” state (step ST1008).

In this embodiment, the call is allocated to a free resource preferentially when there are free resources, but even when the call is allocated to a reserved resource preferentially, it is still possible to achieve the effect that when a call is generated from the communication terminal apparatus 101 which is waiting for a call, a certain proportion of the call is always allocated to reserved resources for stationary terminal apparatuses or reserved resources for moving terminal apparatuses.

Next, the process of the base station apparatus 102 when the communication of the communication terminal apparatus 101 is completed (time 604) will be explained.

When the communication at time 604 is completed, the dedicated channel used for the communication between the communication terminal apparatus 101 and base station apparatus 102 is released according to a channel setting request from the network system 103. At this time, if reserved resources are lacking, the resource reservation allocation section 1052 reserves the lacking resources from the released resources.

Details will be explained with reference to FIG.7. The connection control section 105 receives a channel setting request from the network system 103 (step ST701) In step ST702, the resource securing section 1053 decides the contents of the process of the channel setting request, and since the channel setting request in this case is a resources release process, the resource securing section 1053 moves to step ST706. In step 706, the resource securing section 1053 decides whether the communication terminal apparatus 101 is in the process of handover or not, and since handover is not in progress in this case, the resource securing section 1053 releases the resource secured for the call of the communication terminal apparatus 101. When the resource securing section 1053 gives a signal indicating that the resource secured for the call of the communication terminal apparatus 101 to the terminal state decision section 1054, the terminal state decision section 1054 decides that the terminal state of the communication terminal apparatus 101 is “waiting for a call” and changes the terminal state of the communication terminal apparatus 101 at the terminal state management section 107 from “communication in progress” to “waiting for a call.” The resource securing section 1053 also changes the resource state of the resource secured for the call of the communication terminal apparatus 101 to a “free” state (step ST707). Then, the resource reservation allocation section 1052 performs a resource reservation process of reserving resources corresponding in number to the stationary terminal apparatuses and moving terminal apparatuses (step ST708).

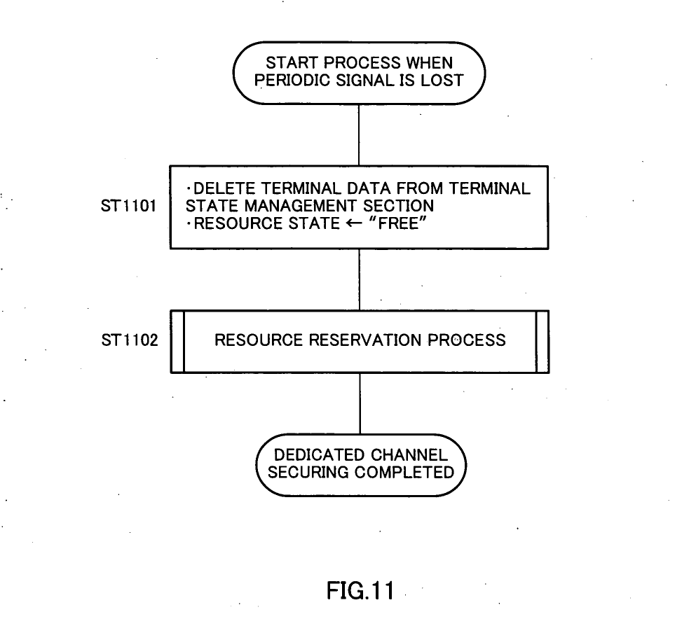

Next, the DETACH process when the power of the communication terminal apparatus 101 is OFF (time 605 to time 606) will be explained with reference to FIG.11. This embodiment is premised on that the base station apparatus 102 cannot distinguish the DETACH process from the ATTACH process or other allocation processes. Therefore, a loss of a periodic signal is regarded as a trigger of a terminal state transition, but when the base station apparatus 102 can distinguish the DETACH from other services, effects similar to those of this embodiment can also be achieved even if a “waiting for a call” state is changed to an “idle” state using the DETACH as a trigger.

At time 605, when the power of the communication terminal apparatus 101 is turned OFF, the communication terminal apparatus 101 outputs a request for performing DETACH to the network system 103 through the base station apparatus 102. Here, as opposed to ATTACH, DETACH is a process which deletes the registration of the communication terminal apparatus 101 on the network system 103 and prevents the communication terminal apparatus 101 from receiving a call from the network system 103 through the base station apparatus 102. After completion of the DETACH process, the communication terminal apparatus 101 ceases to output signals to the base station apparatus 102. The DETACH process also secures a dedicated channel used for a communication between the communication terminal apparatus 101 and network system 103 and releases the dedicated channel at the end of the DETACH process. However, this operation is the same as the operation of the base station apparatus 102 during the ATTACH process, and therefore explanations thereof will be omitted.

The terminal state of the communication terminal apparatus 101 at the terminal state management section 107 before the DETACH process is a “waiting for a call” state. That terminal state becomes a “communication in progress” state when the DETACH process is in progress and returns to the “waiting for a call” state after the DETACH process is finished. However, after the completion of the DETACH process, the communication terminal apparatus 101 does no longer output periodic signals, and therefore the periodic signal detection section 1041 cannot detect any periodic signals output from the communication terminal apparatus 101. Here, the process shown in FIG.11 when a periodic signal is lost is started. When the periodic signal detection section 1041 can no longer detect periodic signals output from the communication terminal apparatus 101, the periodic signal detection section 1041 gives a signal indicating that it is no longer possible to detect periodic signals from the communication terminal apparatus 101 to the resource securing section 1053 and terminal state decision section 1054. In this way, the resource securing section 1053 sets the resource state of the resource secured for the communication terminal apparatus 101 at the resource state management section 109 to the “handover being reserved” 505, and the terminal state decision section 1054 sets the terminal state of the communication terminal apparatus 101 at the terminal state management section 107 to the “handover in progress state” 404. Then, the periodic signal detection section 1041 is provided with a timer section and when a timeout time has elapsed, the periodic signal detection section 1041 gives a signal indicating the lapse of the time to the resource securing section 1053 and terminal state decision section 1054. By so doing, the resource securing section 1053 sets the resource state of the resource secured for the communication terminal apparatus 101 at the resource state management section 109 to the “free” state 501 and the terminal state decision section 1054 sets the terminal state of the communication terminal apparatus 101 at the terminal state management section 107 to the “idle” state 401 and deletes the information of the corresponding communication terminal apparatus 101 from the terminal state management section 107 (step ST1101).

At the end of the DETACH process, the number of communication terminal apparatuses 101 under the control of the base station apparatus 102 decreases and the required number of reserved resources which is proportional to the number of communication terminal apparatuses 101 also decreases, and therefore reserved resources possibly need to be released. Thus, at the end of the DETACH process, the resource reservation allocation section 1052 performs a resource reservation process (step ST1102), calculates the number of reserved resources for stationary terminal apparatuses and moving terminal apparatuses, and when the actual number of reserved resources is larger, the resource reservation allocation section 1052 carries out a process of releasing the reserved resources corresponding to the difference.

When the power of the communication terminal apparatus 101 is not turned OFF, but for some reason, the periodic signal detection section 1041 can no longer detect periodic signals output from the communication terminal apparatus 101 which is “waiting for a call”, the above described DETACH process is not carried out, but when the periodic signals are lost for a certain period, the above described process in step ST1101 is carried out. As a result, as in the case of the end of the DETACH process, the number of communication terminal apparatuses 101 under the control of the base station apparatus 102 decreases and the required number of reserved resources which is proportional to the number of communication terminal apparatuses 101 also decreases, and therefore reserved resources possibly need to be released. Therefore, the resource reservation allocation section 1052 performs a resource reservation process, calculates the number of reserved resources for stationary terminal apparatuses and moving terminal apparatuses, and when the number of current reserved resources is larger, the resource reservation allocation section 1052 performs a process of releasing reserved resources corresponding to the difference.

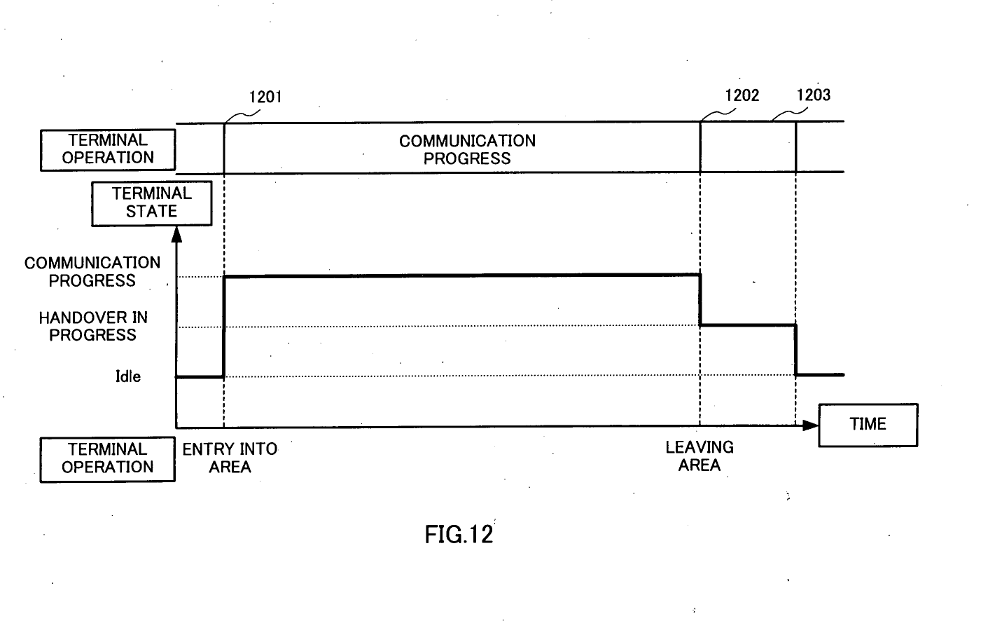

FIG.12 illustrates a change in the terminal state at the terminal state management section 107 of the base station apparatus 102 when the communication terminal apparatus 101 carries out inter-cell handover during a communication, enters from another cell to the own cell and moves out to a different cell while still in communication. The operation of the base station apparatus 102 will be explained along the time axis in FIG.12 with reference to the state transition diagrams in FIG.4 and FIG.5 and the flow charts in FIG.7 to FIG.9.

When the communication terminal apparatus 101 enters from another cell during a communication, the base station apparatus 102 carries out an inter-cell handover operation. FIG.12 illustrates a change in the terminal state when the communication terminal apparatus 101 which has entered (time 1201) from another cell during a communication moves out (time 1202) to a different cell while still in communication likewise. This communication is different from other communications in that neither ATTACH process nor DETACH process is carried out during inter-cell handover.

The communication terminal apparatus 101 which has entered the own cell through inter-cell handover is decided by the decision section 1051 to be a moving terminal apparatus. The base station apparatus 102 needs to secure resources for the communication carried out by the communication terminal apparatus 101 and that process is the dedicated channel securing process shown in FIG.10. Upon completion of this dedicated channel process, the resource securing section 1053 gives a signal indicating that a dedicated channel has been secured for the call of the communication terminal apparatus 101 to the terminal state decision section 1054 and the terminal state decision section 1054 thereby decides the terminal state of the communication terminal apparatus 101 to be “communication in progress” 403 and sets the terminal state of the communication terminal apparatus 101 at the terminal state management section 107 to “communication in progress” 403. Furthermore, upon completion of this dedicated channel process, the resource securing section 1053 sets the resource state of the secured resources at the resource state management section 109 to “busy.”

With regard to a process when the terminal goes out of the cell, when a communication is interrupted due to deterioration of the radio wave situation and then the radio wave situation takes a turn for the better and the communication is enabled again, it is necessary to recover from the interrupted communication, and therefore unlike a normal release of resources, a timeout time is provided for the “handover being reserved” state 505 and when the interruption of the communication continues for a certain period due to deterioration of intensity of the radio wave (time 1203), it is decided that the terminal has gone out of the own cell. That is, when the periodic signal detection section 1041 can no longer detect periodic signals output from the communication terminal apparatus 101, the periodic signal detection section 1041 gives a signal indicating that it is no longer possible to detect periodic signals from the communication terminal apparatus 101 to the resource securing section 1053 and terminal state decision section 1054. In this way, the resource securing section 1053 sets the resource state of the resources secured for the communication terminal apparatus 101 at the resource state management section 109 to the “handover being reserved” 505 and the terminal state decision section 1054 sets the terminal state of the communication terminal apparatus 101 at the terminal state management section 107 to a “handover in progress” state 404. Then, the periodic signal detection section 1041 is provided with a timer section and when a timeout times has elapsed, the periodic signal detection section 1041 gives a signal indicating the lapse of the timeout time to the resource securing section 1053 and terminal state decision section 1054. Thus, the resource securing section 1053 sets the resource state of the resources secured for the communication terminal apparatus 101 at the resource state management section 109 to a “free” state 501 and the terminal state decision section 1054 sets the terminal state of the communication terminal apparatus 101 at the terminal state management section 107 to an “idle” state 401.

Therefore, in Embodiment 1, the base station apparatus takes into consideration whether the communication terminal apparatus 101 is waiting for a call or not, decides whether the communication terminal apparatus 101 is stationary or moving, performs state management according to the actual state of the communication terminal apparatus 101, reserves resources for moving terminal apparatuses and stationary terminals appropriately, and can thereby secure resources of the base station apparatus 102 for the respective moving terminal apparatuses and stationary terminal apparatuses reliably.

Furthermore, according to Embodiment 1, the result of a decision as to whether the communication terminal apparatus 101 is stationary or moving is changed according to the actual state of the communication terminal apparatus 101, and therefore it is possible to reserve resources more appropriately, thereby secure resources of the base station apparatus 102 for the respective moving terminal apparatuses and stationary terminal apparatuses more reliably.

Furthermore, in Embodiment 1 the base station apparatus changes the result of a decision as to whether the communication terminal apparatus 101 is stationary or moving according to the actual state of the communication terminal apparatus 101, and can thereby prevent interference with communication terminal apparatuses which are actually stationary.

### Embodiment 2

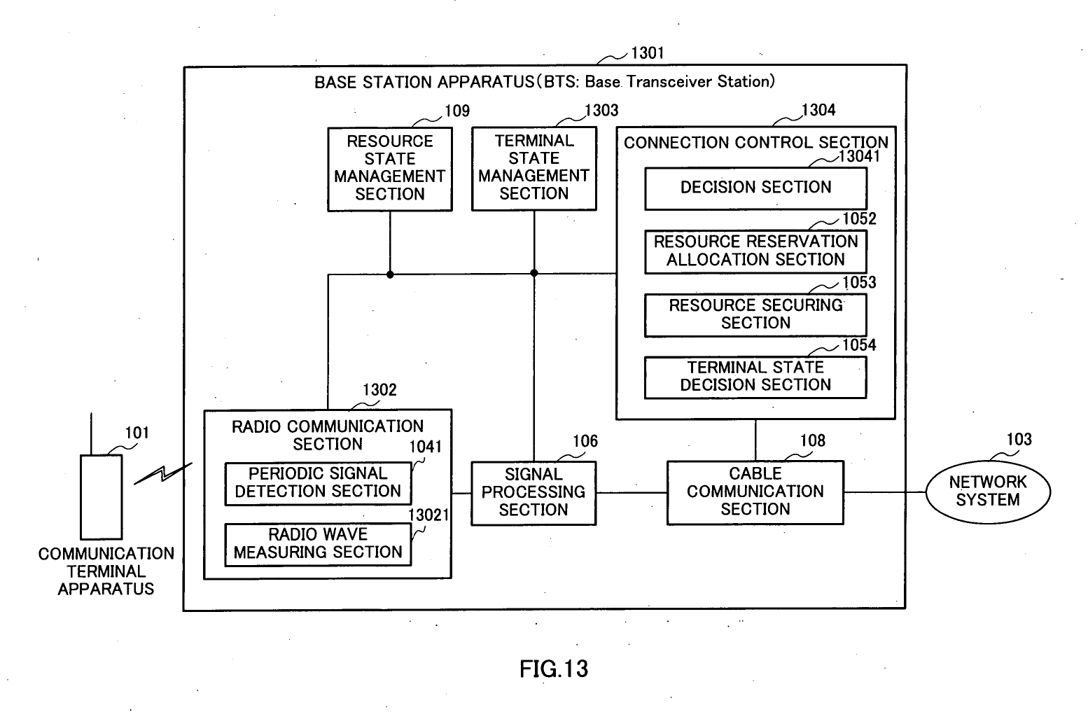

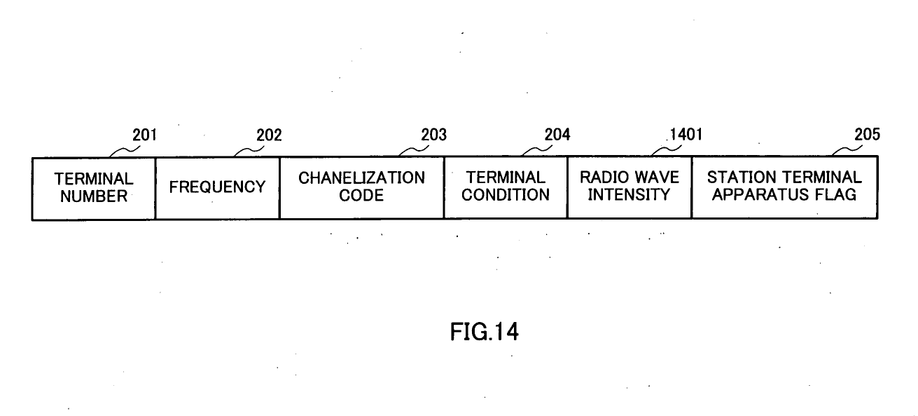

FIG.13 is a block diagram showing a configuration of a base station apparatus 1301 according to Embodiment 2. FIG.14 illustrates a field of a terminal state management section 1303. In Embodiment 2, the same components as those of the base station apparatus 102 according to Embodiment 1 are assigned the same reference numerals and explanations thereof will be omitted.

The base station apparatus 1301 is provided with a radio communication section 1302, a signal processing section 106, a terminal state management section 1303, a connection control section 1304, a cable communication section 108 and a resource state management section 109. The radio communication section 1302 is provided with a periodic signal detection section 1041 and a radio wave measuring section 13021. The connection control section 1304 is provided with a decision section 13041, a resource reservation allocation section 1052, a resource securing section 1053 and a terminal state decision section 1054.

The radio wave measuring section 13021 measures the value of reception power of a radio wave emitted from the communication terminal apparatus 101 and records the value and history in radio wave intensity 1401 of the field of the terminal state management section 1303 shown in FIG.14. The decision section 13041 monitors a variation of the value of the reception power based on the value of the reception power of the radio wave emitted from the communication terminal apparatus 101 recorded in the radio wave intensity 1401 in the field of the terminal state management section 1303 and the history at certain time intervals, decides, when the variation falls within a certain range, that the communication terminal apparatus 101 is a stationary terminal apparatus and decides, when the variation does not fall within a certain range, that the communication terminal apparatus 101 is a moving terminal apparatus. When the radio wave measuring section 13021 performs RAKE combining after a delay profile of the received signal is created, the radio wave measuring section 13021 records a correlation value, etc., after RAKE combining in the radio wave intensity 1401 of the field of the terminal state management section 1303, and therefore the decision section 13041 may also be adapted so as to decide whether the communication terminal apparatus 101 is a stationary terminal apparatus or moving terminal apparatus based on the variation of the correlation value obtained from the correlation value after RAKE combining recorded in the radio wave intensity 1401 in the field of the terminal state management section 1303.

Next, assuming that FIG.6 illustrates five processes (ATTACH, waiting for a call, communication start, communication end and DETACH) carried out by the communication terminal apparatus 101 when the user of the communication terminal apparatus 101 performs four operations of power ON, transmission/reception by the communication terminal apparatus 101 and connection and disconnection of a call and changes of the terminal state at the terminal state management section 1303, the operation of the base station apparatus 1301 will be explained along the time axis in FIG.6 with reference to the state transition diagrams in FIG.4 and FIG.5 and flow charts in FIG.7 to FIG.9. However, only the part of the operation different from the operation of the base station apparatus 102 explained in Embodiment 1 will be explained.

The part of the operation of the base station apparatus 1301 which differs from the operation of the base station apparatus 102 explained in Embodiment 1 is a method of deciding whether the communication terminal apparatus 101 is a stationary terminal apparatus or moving terminal apparatus carried out by the decision section 13041 during a “waiting for a call” state from time 602 to time 603.

After the terminal state of the terminal state management section 107 becomes a “waiting for a call” state, the radio wave measuring section 13021 measures the radio wave intensity of a signal output from the communication terminal apparatus 101 at certain intervals (dm) and stores the measuring result in the radio wave intensity 1401 of the field of the terminal state management section 107. Data based on the delay profile used for Rake reception may also be stored in the area of the radio wave intensity 1401. According to W-CDMA, a signal of a mobile station is divided into a plurality of portions due to obstacles, etc., and those signal portions arrive at the base station, and therefore the base station apparatus 1301 on the receiving side despreads signals of all paths at different times to thereby detect the signals. When detection is carried out, all delays up to an upper limit determined chip by chip are artificially created, a table of correspondence (delay profile) between delay times and transmit power values is created and a plurality of delay times whose power level is greater than a threshold is selected. When signals are received, all signals having the selected delay times are weighted with reception power and then signals are received. When the communication terminal apparatus 101 is moving, the variation among these delay times becomes greater than that when the terminal is stationary, this can also be used to distinguish a moving terminal apparatus from a stationary terminal apparatus.

For example, in a delay profile, suppose only signals having delays of 0.1 sec and 0.15 sec from the first received signal exceed a threshold and have reception power of −60 dbm and −80 dbm respectively. Then, delay times (0, 0.1, 0.15) and reception power (−60, −70, −80) are recorded in the radio wave intensity field. The decision section 13041 of the connection control section 105 acquires data of the radio wave intensity 1401 corresponding to a predetermined time (dd) at predetermined intervals (dc) and checks the change rate of radio wave intensity with respect to time. dc must be longer than a measuring interval dm and dm is set to, for example, approximately 1 sec, and both dc and dd are set to approximately 1 minute.

The change rate is obtained by acquiring all measuring results of the dd time and calculating dispersion for every measured value. When the dispersion exceeds a threshold, the decision section 13041 decides that the communication terminal apparatus 101 is a moving terminal apparatus and when dispersion does not exceed the threshold, the decision section 13041 decides that the communication terminal apparatus 101 is a stationary terminal apparatus. When the decision result shows that the communication terminal apparatus 101 is a stationary terminal apparatus, the decision section 13041 sets the stationary terminal apparatus flag of the state management section 1303 to ON and when the result shows that the communication terminal apparatus 101 is a moving terminal apparatus, the decision section 13041 sets the stationary terminal apparatus flag of the terminal state management section 1303 to OFF.

If the base station apparatus 1301 saves information on the radio wave intensity at all times of all communication terminal apparatuses 101 in the own cell, this may cause a great burden to the processing capacity and hardware cost. However, even when the range of times to be measured is narrowed, it is still possible to achieve the effects of this embodiment. For example, using a method of determining a measuring range such as 1 minute, 5 minutes beforehand and recording only the data corresponding to the past measuring range and discarding the rest or a method of recording data only for 5 minutes once every hour, it is still possible to obtain the effects of this embodiment.

When the base station apparatus 1301 is used in private network, it is also possible to achieve the effects of this embodiment using a decision method of placing a radio wave generator which has been fixed separately and completely stationary in the cell and comparing the variation in the radio wave intensity of the radio wave generated by the radio wave generator measured at the base station apparatus 1301 with the variation in the radio wave intensity of a periodic signal generated by the communication terminal apparatus 101 and deciding that the communication terminal apparatus 101 is a stationary terminal apparatus when both variations are similar.

Furthermore, with a device or network in a special mode, it is also possible to achieve effects similar to those of this embodiment using a method of deciding the following communication terminal apparatus 101 to be a stationary terminal apparatus. Examples of this include a communication terminal apparatus 101 charged using a charger connected to a base station apparatus 1301 for private use or a communication terminal apparatus 101 not registered on a presence server which is linked therewith and indicates the locations of the base station apparatus 1301 and communication terminal apparatus 101.

Therefore, in Embodiment 2 the base station apparatus can take into account whether the communication terminal apparatus 101 is waiting for a call or not, decide whether the communication terminal apparatus 101 is stationary or moving, perform state management according to the actual state of the communication terminal apparatus 101, appropriately reserve resources for the respective moving terminal apparatuses and stationary terminals, and can thereby secure resources of the base station apparatus 1301 for the moving terminal apparatus and stationary terminal apparatus.

Furthermore, in Embodiment 2 the base station apparatus changes the result of a decision as to whether the communication terminal apparatus 101 is stationary or moving according to the actual state of the communication terminal apparatus 101 based on the variation in radio wave intensity measured by the radio wave measuring section 13021, and can thereby reserve resources more appropriately and secure resources of the base station apparatus 1301 for the respective moving terminal apparatuses and stationary terminal apparatuses more reliably.

Furthermore, in Embodiment 2 the base station apparatus changes the result of a decision as to whether the communication terminal apparatus 101 is stationary or moving according to the actual state of the communication terminal apparatus 101 based on the variation in the radio wave intensity measured by the radio wave measuring section 13021, and can thereby prevent interference with the actually stationary communication terminal apparatus 101.

As described above, the base station apparatus according to an embodiment of the present invention takes into consideration whether the communication terminal apparatus is waiting for a call or not, decides whether the waiting communication terminal apparatus is stationary or moving and reserves resources according to the respective numbers of the moving communication terminal apparatuses and stationary communication terminal apparatuses, and can thereby secure resources for the respective moving communication terminal apparatuses and stationary communication terminal apparatuses reliably.

Especially, this embodiment decides the communication terminal apparatus to be in communication when resources are secured for the communication terminal apparatus and decides the communication terminal apparatus to be waiting for a call when the communication terminal apparatus has registered the position in the base station apparatus and can receive a call from another communication terminal apparatus, and can thereby secure resources for the respective moving communication terminal apparatuses and stationary communication terminal apparatuses reliably.

Furthermore, when a communication terminal apparatus registers the position in the cell, it is decided that the communication terminal apparatus is moving and then, when signals periodically output from the communication terminal apparatus are detected for a certain period of time, the decision result is changed from “moving” to “stationary”, and in this way the result of a decision as to whether the communication terminal apparatus is stationary or moving is changed from “moving” to “stationary” according to the actual state of the communication terminal apparatus, and therefore it is possible to reserve resources more appropriately and thereby secure resources for the respective moving communication terminal apparatuses and stationary communication terminal apparatuses more reliably. Furthermore, according to this configuration, the decision result as to whether the communication terminal apparatus is stationary or moving is changed according to the actual state of the communication terminal apparatus, and therefore it is possible to prevent interference with the actually stationary communication terminal apparatuses.

Furthermore, when a communication terminal apparatus registers the position in the cell, it is decided that the communication terminal apparatus is moving and then, when signals periodically output from the communication terminal apparatus are detected, and the variation in the radio wave intensity of the radio wave intensity falls within a certain range, the decision result is changed from “moving” to “stationary” and the decision result as to whether the communication terminal apparatus is stationary or moving is changed according to the actual state of the communication terminal apparatus, and therefore it is possible to reserve resources more appropriately and secure resources for the respective moving communication terminal apparatuses and stationary communication terminal apparatuses more reliably. Furthermore, according to this configuration, the decision result as to whether the communication terminal apparatus is stationary or moving is changed according to the actual state of the communication terminal apparatus, and therefore it is possible to prevent interference with the actually stationary communication terminal apparatuses.

Furthermore, signals periodically output by the communication terminal apparatus are channelization code, scrambling code or periodic update of a common channel, and therefore it is possible to change the result of a decision as to whether the communication terminal apparatus is stationary or moving according to the actual state of the communication terminal apparatus, reserve resources more appropriately and thereby secure resources for the respective moving communication terminal apparatuses and stationary communication terminal apparatuses more reliably. Furthermore, according to this configuration, the result of a decision as to whether the communication terminal apparatus is stationary or moving is changed according to the actual state of the communication terminal apparatus, and therefore it is possible to prevent interference with actually stationary communication terminal apparatuses.

Furthermore, since the resources of the base station apparatus are allocated as resources reserved for stationary communication terminal apparatuses and resources reserved for moving communication terminal apparatuses representing certain rates in the total number of stationary communication terminal apparatuses and moving communication terminal apparatuses in the cell, it is possible to reserve resources for the respective moving communication terminal apparatuses and stationary communication terminal apparatuses appropriately and secure resources for the respective moving communication terminal apparatuses and stationary communication terminal apparatuses reliably.

Furthermore, when resources of the base station apparatus are secured for the communication terminal apparatus, unreserved resources are secured first, and therefore it is possible to secure resources for the respective moving communication terminal apparatuses and stationary communication terminal apparatuses more reliably.

Furthermore, when the communication terminal apparatus finishes a communication or the communication terminal apparatus moves to another cell through handover, if the secured resources are released, the number of reserved resources to be allocated for the stationary communication terminal apparatuses and the number of reserved resources for the moving communication terminal apparatuses are recalculated, and when the actual number of reserved resources is lacking, reserved resources are added from resources other than the reserved resources and resources secured for the communication terminal apparatus in communication, and therefore it is possible to take into consideration whether the communication terminal apparatus is waiting for a call or not, decide whether the communication terminal apparatus is stationary or moving, perform state management according to the actual state of the communication terminal apparatus, reserve resources for the respective moving communication terminal apparatuses and stationary communication terminal apparatuses appropriately and secure resources for the respective moving communication terminal apparatuses and stationary communication terminal apparatuses reliably. Furthermore, according to this configuration, the result of a decision as to whether the communication terminal apparatus is stationary or moving is changed according to the actual state of the communication terminal apparatus, and therefore it is possible to reserve resources more appropriately and reserve resources for the respective moving communication terminal apparatuses and stationary communication terminal apparatuses more reliably. Furthermore, according to this configuration, the result of a decision as to whether the communication terminal apparatus is stationary or moving is changed according to the actual state of the communication terminal apparatus, and therefore it is possible to prevent interference with the actually stationary communication terminal apparatuses.

Furthermore, according to a resource reservation allocation method of the base station apparatus according to an embodiment of the present invention, the communication terminal apparatus decides the terminal state “waiting for a call”, decides whether the communication terminal apparatus is stationary or moving, and reserves resources according to the numbers of moving communication terminal apparatuses and stationary communication terminal apparatuses, and therefore it is possible to reserve resources for the respective moving communication terminal apparatuses and stationary communication terminal apparatuses appropriately and secure resources for the respective moving communication terminal apparatuses and stationary communication terminal apparatuses reliably.

Especially, when the communication terminal apparatus registers the position in the cell, the communication terminal apparatus is decided to be “moving” and when signals periodically output from the communication terminal apparatus are detected for a certain period thereafter, the decision result is changed from “moving” to “stationary”, and therefore it is possible to change the result of a decision as to whether the communication terminal apparatus is stationary or moving according to the actual state of the communication terminal apparatus and reserve resources more appropriately and thereby reserve resources for the respective moving communication terminal apparatuses and stationary communication terminal apparatuses more reliably.

Furthermore, according to this method, the result of a decision as to whether the communication terminal apparatus is stationary or moving is changed according to the actual state of the communication terminal apparatus, and therefore it is possible to prevent interference with the actually stationary communication terminal apparatuses.

Furthermore, when the communication terminal apparatus registers the position in the cell, the communication terminal apparatus is decided to be “moving” and when the variation in the radio wave intensity of signals falls within a certain range thereafter, the decision result is changed from “moving” to “stationary”, and therefore it is possible to change the result of a decision as to whether the communication terminal apparatus is stationary or moving according to the actual state of the communication terminal apparatus, reserve resources more appropriately and reserve resources for the respective moving communication terminal apparatuses and stationary communication terminal apparatuses more reliably. Furthermore, according to this method, the result of a decision as to whether the communication terminal apparatus is stationary or moving is changed according to the actual state of the communication terminal apparatus, and therefore it is possible to prevent interference with the actually stationary communication terminal apparatuses.

Furthermore, since the resources of the base station apparatus are allocated as resources reserved for stationary communication terminal apparatuses and resources reserved for moving communication terminal apparatuses representing certain rates in the total number of stationary communication terminal apparatuses and moving communication terminal apparatuses in the cell, when the resources of the base station apparatus are secured for the communication terminal apparatus which starts a communication, unreserved resources are secured first and when the communication terminal apparatus finishes the communication or when the communication terminal apparatus moves to another cell through handover and the resources secured for the communication terminal apparatus are released, the numbers of resources reserved for the stationary communication terminal apparatuses to be allocated and resources reserved for the moving communication terminal apparatuses are recalculated, and if the actual number of reserved resources is lacking, reserved resources are added from resources other than the reserved resources and resources reserved for the communication terminal apparatus in communication, and therefore when the resources of the base station apparatus are secured for the communication terminal apparatus which starts a communication, it is possible to secure unreserved resources first and secure resources for the respective moving communication terminal apparatuses and stationary communication terminal apparatuses more reliably.

Therefore, according to an embodiment of the present invention, the base station apparatus can take into consideration whether the communication terminal apparatus is waiting for a call or not, decides whether the communication terminal apparatus is stationary or moving according to the actual state of the communication terminal apparatus, perform state management of the communication terminal apparatus and allocate resources to the respective moving communication terminal apparatuses and stationary communication terminal apparatuses appropriately.

As a result, the base station apparatus and resource reservation allocation method of the base station apparatus according to the present invention is useful because of the ability to take into consideration whether the communication terminal apparatus is waiting for a call or not, decide whether the communication terminal apparatus is stationary or moving according to the actual state of the communication terminal apparatus, perform state management of the communication terminal apparatus and allocate resources to the respective moving communication terminal apparatuses and stationary communication terminal apparatuses appropriately.

The present invention is not limited to the above described embodiments, and various variations and modifications may be possible without departing from the scope of the present invention.

This application is based on the Japanese Patent Application No. 2003-376125 filed on Nov. 5, 2003, entire content of which is expressly incorporated by reference herein.

[FIG. 1]
102 BASE STATION APPARATUS
109 RESOURCE STATE MANAGEMENT SECTION
107 TERMINAL STATE MANAGEMENT SECTION
105 CONNECTION CONTROL SECTION
1051 DECISION SECTION
1052 RESOURCE RESERVATION ALLOCATION SECTION
1053 RESOURCE SECURING SECTION
1054 TERMINAL STATE DECISION SECTION
101 COMMUNICATION TERMINAL APPARATUS
104 RADIO COMMUNICATION SECTION
1041 PERIODIC SIGNAL DETECTION SECTION
106 SIGNAL PROCESSING SECTION
108 CABLE COMMUNICATION SECTION
103 NETWORK SYSTEM

[FIG. 2]
201 TERMINAL NUMBER
202 FREQUENCY
203 CHANELIZATION CODE
204 TERMINAL STATE
205 STATIONARY TERMINAL APPARATUS FLAG

[FIG. 3]
301 RESOURCE NUMBER
302 RESOURCE STATE
303 ALLOCATED TERMINAL NUMBER
FREE
BUSY
STATIONARY TERMINAL APPARATUS BEING RESERVED
MOVING TERMINAL APPARATUS BEING RESERVED

[FIG. 4]
401 IDLE
TIMEOUT
404 HANDOVER IN PROGRESS
PERIODIC SIGNALS LOST
DETACH
ATTACH
CONTROL CHANNEL SECURED/RELEASED
ENTERING COVERAGE AREA BY HANDOVER
RETURNED TO COVERAGE AREA BEFORE TIMEOUT
RECOVERY OF PERIODIC SIGNALS
GOING OUT OF COVERAGE AREA BY HANDOVER
PERIODIC SIGNALS LOST
402 WAITING FOR CALL
DEDICATED CHANNEL SECURED
DEDICATED CHANNEL RELEASED
403 COMMUNICATION IN PROGRESS

[FIG. 5]
502 MOVING TERMINAL APPARATUS BEING RESERVED
RESOURCE RESERAVATION ALLOCATED
RESERVED RESOURCE RELEASED
501 FREE
TIMEOUT
505 HANDOVER BEING RESERVED
RESOURCES SECURED
RESOURCE RESERVATION ALLOCATED
RESERVED RESOURCE RELEASED
RESOURCES RELEASED
RESOURCES SECURED
HANDOVER TAKES PLACE
503 STATIONARY TERMINAL APPARATUS BEING RESERVED
RESOURCES SECURED
504 BUSY
RESOURCES SECURED (RETURNS TO COVERAGE AREA)

[FIG. 6]
TERMINAL OPERATION
COMMUNICATION IN PROGRESS
TERMINAL STATE
COMMUNICATION IN PROGRESS
WAITING FOR CALL
PERIODIC SIGNALS LOST
TERMINAL OPERATION
POWER ON
TRANSMISSION/RECEPTION
MAIL TRANSMISSION/RECEPTION
COMMUNICATION END
POWER OFF
TIME

[FIG. 7]
ALLOCATION/RELEASE
ST701 RECEIVE CHANNEL SETTING REQUEST FROM NETWORK
ST702 CONTENTS OF CHANNEL SETTING
RELEASE
ALLOCATE
ST703 DECIDE TYPE OF CALL PROCESS
OTHER
ST704 PROCESS: ATTACH
ST705 PROCESS: SECURE DEDICATED CHANNEL
ALLOCATION/RELEASE COMPLETED
ST706 HANDOVER IN PROGRESS?
ST707 STATE OF TERMINAL STATE MANAGEMENT SECTION←“WAITING FOR A CALL”
RESOURCE STATE←“FREE”
ST708 RESOURCE RESERVATION PROCESS
ST709 STATE OF TERMINAL STATE MANAGEMENT SECTION←“HANDOVER IN PROGRESS”
RESOURCE STATE←“FREE”
ST710 RESOURCE RESERVATION PROCESS

[FIG. 8]
ST801 IS THERE FREE SPACE?
ST802 ALLOCATE CALL TO FREE RESOURCE AND SET STATE TO “BUSY”
ST806 REGISTER CHANELIZATION CODE IN TERMINAL STATE MANAGEMENT SECTION
ST807 RESOURCE RESERVATION PROCESS
ATTACH COMPLETED
ST803 ARE THERE RESRVED RESOURCES IN “MOVING TERMINAL APPARATUS BEING RESERVED”?
ST804 ALLOCATE CALLS TO FREE RESOURCES AND SET STATE TO “BUSY”
ST805 REGARD AS CALL LOSS
ATTACH COMPLETED (FAILURE)

[FIG. 9]
START RESOURCE RESERVATION PROCESS
ST901 CALCULATE NUMBER OF RESERVED RESOURCES OF MOVING TERMINAL APPARATUSES AND STATIONARY TERMINAL APPARATUSES
ST902 REQUIRED NUMBER OF RESERVED RESOURCES<ACTUAL NUMBER OF RESERVATIONS FOR STATIONARY TERMINAL APPARATUSES?
ST903 ARE THERE FREE RESOURCES?
ST904 SET FREE RESOURCES CORRESPONDING IN NUMBER TO LACKING RESERVED RESOURCES AND FREE RESOURCES, WHICHEVER IS SMALLER, TO “STATIONARY TERMINAL APPARATUS BEING RESERVED”
ST905 REQUIRED NUMBER OF RESERVED RESOURCES<ACTUAL NUMBER OF RESERVATIONS FOR MOVING TERMINAL APPARATUSES?
ST906 ARE THERE FREE RESOURCES?
ST907 SET FREE RESOURCES CORRESPONDING IN NUMBER TO LACKING RESERVED RESOURCES AND FREE RESOURCES, WHICHEVER IS SMALLER, TO “MOVING TERMINAL APPARATUS BEING RESERVED” END OF RESOURCE RESERVATION PROCESS

[FIG. 10]
SECURE DEDICATED CHANNEL
ST1001 ARE THERE FREE RESOURCES?
ST1003 THERE ARE “STATIONARY TERMINAL APPARATUS BEING RESERVED” RESOURCES & TERMINAL STATIONARY TERMINAL FLAG ON?
ST1002 ALLOCATE CALLS TO FREE RESOURCES
ST1005 THERE ARE “MOVING TERMINAL APPARATUS BEING RESERVED” RESOURCES & TERMINAL STATIONARY TERMINAL FLAG OFF?
ST1004 ALLOCATE CALLS TO “STATIONARY TERMINAL APPARATUS BEING RESERVED” RESOURCES
ST1006 ALLOCATE CALLS TO “MOVING TERMINAL APPARATUS BEING RESERVED” RESOURCES
ST1008 SET STATE OF TERMINAL STATE MANAGEMENT SECTION TO “COMMUNICATION IN PROGRESS”
DEDICATED CHANNEL SECURING COMPLETED
ST1007 REGARD AS CALL LOSS
DEDICATED CHANNEL SECURING (FAILURE)

[FIG. 11]
START PROCESS WHEN PERIODIC SIGNAL IS LOST
ST1101 DELETE TERMINAL DATA FROM TERMINAL STATE MANAGEMETN SECTION
RESOURCE STATE←“FREE”
ST1102 RESOURCE RESERVATION PROCESS
DEDICATED CHANNEL SECURING COMPLETED

[FIG. 12]
TERMINAL OPERATION
COMMUNICATION IN PROGRESS
TERMINAL STATE
COMMUNICATION IN PROGRESS
HANDOVER IN PROGRESS
TERMINAL OPERATION
ENTRY INTO AREA
LEAVING AREA
TIME

[FIG. 13]
1301 BASE STATION APPARATUS
109 RESOURCE STATE MANAGEMENT SECTION
1303 TERMINAL STATE MANAGEMENT SECTION
1304 CONNECTION CONTROL SECTION
13041 DECISION SECTION
1052 RESOURCE RESERVATION ALLOCATION SECTION
1053 RESOURCE SECURING SECTION
1054 TERMINAL STATE DECISION SECTION
101 COMMUNICATION TERMINAL APPARATUS
1302 RADIO COMMUNICATION SECTION
1041 PERIODIC SIGNAL DETECTION SECTION
13021 RADIO WAVE MEASURING SECTION
106 SIGNAL PROCESSING SECTION
108 CABLE COMMUNICATION SECTION
103 NETWORK SYSTEM

[FIG. 14]
201 TERMINAL NUMBER
202 FREQUENCY
203 CHANELIZATION CODE
204 TERMINAL STATE
1401 RADIO WAVE INTENSITY
205 STATIONARY TERMINAL APPARATUS FLAG

1. A base station apparatus comprising:
a terminal state decision section that decides a terminal state as to whether a communication terminal apparatus which belongs to a cell covered by said base station apparatus itself is in communication or waiting for a call;
a decision section that decides whether said communication terminal apparatus decided by said terminal state decision section to be in communication or waiting for a call is stationary or moving and creates a decision result; and
a resource reservation allocation section that reserves resources for said respective apparatuses according to the number of said moving communication terminal apparatuses and the number of said stationary communication terminal apparatuses calculated based on said decision result.

2. The base station apparatus according to claim 1, wherein said terminal state decision section decides that said communication terminal apparatus is in communication, when said resources are secured for said communication terminal apparatus and decides that said communication terminal apparatus is waiting for a call when said communication terminal apparatus registers the position in said base station apparatus and can receive a call from said other communication terminal apparatus.

3. The base station apparatus according to claim 1, further comprising a periodic signal detection section that detects signals periodically output by said communication terminal apparatus,
wherein said decision section decides that said communication terminal apparatus is moving when said communication terminal apparatus registers the position in said cell and changes said decision result from “moving” to “stationary” when said periodic signal detection section detects said signals from said communication terminal apparatus for a certain period of time thereafter.

4. The base station apparatus according to claim 1, further comprising a radio wave measuring section that detects signals periodically output by said communication terminal apparatus and measures radio wave intensity of said signals,
wherein said decision section decides that said communication terminal apparatus is moving when said communication terminal apparatus registers the position in said cell and changes said decision result from “moving” to “stationary” when a variation in the radio wave intensity of said signal detected by said radio wave measuring section falls within a predetermined range thereafter.

5. The base station apparatus according to claim 3, wherein said signals periodically output by said communication terminal apparatus are channelization codes, scrambling codes or periodic update of a common channel.

6. The base station apparatus according to claim 1, wherein said resource reservation allocation section allocates resources reserved for said stationary communication terminal apparatuses and resources reserved for said moving communication terminal apparatuses representing certain rates of the total numbers of said stationary communication terminal apparatuses and said moving communication terminal apparatuses in said cell from resources of the base station apparatus.

7. The base station apparatus according to claim 1, further comprising a resource securing section that secures the resources of the base station apparatus for said communication terminal apparatus which starts a communication,
wherein said resource securing section secures unreserved resources first when said resources of said base station apparatus are secured for said communication terminal apparatus which starts said communication.

8. The base station apparatus according to claim 1, wherein when said communication terminal apparatus finishes a communication or when said communication terminal apparatus moves to another cell through handover, said resource reservation allocation section recalculates the number of resources reserved for said stationary communication terminal apparatuses and the number of resources reserved for said moving communication terminal apparatuses when said resources secured by said resource securing section are released and adds said reserved resources from said reserved resources and said resources other than said resources secured for said communication terminal apparatuses when the actual number of reserved resources is lacking.

9. A method of allocating resource reservations at a base station apparatus comprising:
a step of deciding whether a communication terminal apparatus is waiting for a call or not;
a step of deciding whether said communication terminal apparatus decided to be waiting for a call is stationary or moving and creating a decision result; and
a resource reservation allocating step of allocating reservations of resources for said respective apparatuses according to the number of said moving communication terminal apparatuses and the number of said stationary communication terminal apparatuses calculated based on said decision result.

10. The method of allocating resource reservations at a base station apparatus according to claim 9, further comprising:
a step of deciding, when said communication terminal apparatus registers the position in said cell, that said communication terminal apparatus is moving; and
a step of changing said decision result from “moving” to “stationary” when said signal from said communication terminal apparatus is detected for a certain period thereafter.

11. The method of allocating resource reservations at a base station apparatus according to claim 9, further comprising:
a step of deciding, when said communication terminal apparatus registers the position in said cell, that said communication terminal apparatus is moving; and
a step of changing said decision result from “moving” to “stationary” when a variation in the radio wave intensity of said signal falls within a certain range.

12. The method of allocating resource reservations at a base station apparatus according to claim 9, further comprising:
a step of allocating the resources of said base station apparatus as resources reserved for said stationary communication terminal apparatuses and resources reserved for said moving communication terminal apparatuses representing certain rates in the total number of said stationary communication terminal apparatuses and said moving communication terminal apparatuses in said cell;
a step of securing said resources not reserved when said resources of said base station apparatus are secured for said communication terminal apparatus which starts a communication first; and
a step of recalculating, when said communication terminal apparatus finishes a communication or when said communication terminal apparatus moves to another cell through handover, the numbers of resources reserved for said stationary communication terminal apparatuses and resources reserved for said moving communication terminal apparatuses when said resources secured for said communication terminal apparatuses are released and adding said reserved resources and said resources other than said resources secured for said communication terminal apparatuses when the actual number of reserved resources is lacking to said reserved resources.
